(19) United States
(12) Patent Application Publication
(10) Pub. No.: US 2005/0217506 A1
(43) Pub. Date: Oct. 6, 2005

(54) Cotton packager floor including friction reducing surface

(75) Inventors: Timothy A. Meeks, Davenport, IA (US); Michael J. Covington, Bettendorf, IA (US)

Correspondence Address: CNH AMERICA LLC, INTELLECTUAL PROPERTY LAW DEPARTMENT, 700 STATE STREET, RACINE, WI, 53404, US

(73) Assignee: CNH America LLC

(21) Appl. No.: 11/089,659

(22) Filed: Mar. 25, 2005

Related U.S. Application Data
(60) Provisional application No. 60/557,911, filed on Mar. 30, 2004.

(51) Int. Cl. B30B 5/06

(52) U.S. Cl. 100/88

(57) ABSTRACT

A cotton packager including a floor surface for supporting a compacted body of cotton, the floor surface including at least one sheet of a low friction polymer material on which the compacted body of cotton is supported, for facilitating movement and conveyance of the compacted body of cotton from the packager. The packager can include an unloading ramp pivotable to an unloading position extending outwardly from the floor surface and including a conveyor surface including at least one sheet of a low friction polymer material, for facilitating passage of a compacted body of cotton thereover. The floor surface and the conveyor surface can each include at least one conveyor chain thereon, supported on the low friction polymer material sheet, or in channels.

This application claims the benefit of U.S. Provisional Application No. 60/557,911, filed Mar. 30, 2004.

### TECHNICAL FIELD

This invention relates generally to the floor of a cotton packager or module building chamber, and more particularly, to a packager floor including a friction reducing surface for reducing the outward force required for unloading a compacted body of cotton or module from the chamber.

### BACKGROUND ART

The cotton compacting chamber of an on-board cotton packager or module builder of a cotton harvesting machine typically includes four walls, a floor, a lid, and compactor apparatus supported in the chamber and movable downwardly against cotton collected therein for compacting or forming a dense, unitary compacted body of cotton or module. An important objective of such packagers is to make a compacted body or module of cotton which will remain substantially cohesive and unitary during subsequent handling, including during unloading, and loading into a transport vehicle such as a truck or the like. Typically, the floor of the compacting or module building chamber is a live floor, that is, it includes chains or other conveyor elements which are movable in a direction toward an unloading door of the chamber for conveying the compacted body or module of cotton from the chamber. As a result of the compacting force required to achieve the desired degree of cotton density, as well as the weight of the resultant compacted body or module, and other conditions, it can be very difficult for the chains to move the module by sliding it over the surface of the floor, particularly to initiate the movement. A greater number of the conveyor chains, as well as larger drive motors are required to overcome the friction between the bottom surface of the cotton module and the surface of the floor. This results in disadvantages including added cost and weight. Additionally, a door or ramp is typically associated with an unloading opening of the chamber in parallel relation to the floor, to provide a surface over which the compacted body of cotton or module can be conveyed and deposited at a desired location, such as the ground or the like.

Thus, what is sought is a surface for a floor of a cotton compacting chamber of a packager or module builder, and also for a door or ramp associated therewith, which reduces friction and other conditions which impede the conveyance and unloading of a compacted body or module of cotton thereover.

### SUMMARY OF THE INVENTION

What is disclosed is a surface for the interior floor of a cotton compacting chamber of a cotton packager or module builder and a door or ramp associated therewith, which overcomes one or more of the problems and shortcomings discussed above.

The surface of the invention comprises a low friction polymer sheet or sheets of a material such as, but not limited to, sheets of high density polyethylene, ultrahigh molecular weight polyethylene, and similar plastics, preferably having a coefficient of friction within a range of from about 0.1 to about 0.3, such as commercially available from, for instance, Alert Manufacturing and Supply Co. of West Des Moines, Iowa, located on the floor, which has been found to greatly reduce the friction between the compacted body or module of cotton and the floor. The sheets can extend beneath the chains to provide a smooth, low friction surface for movement thereover, or other means, such as recessed channels or guides can be provided for the chains, as desired or required for a particular application. The sheets are also replaceable.

The low friction sheets can also be utilized on cotton conveying surfaces of an unloader door or ramp in the same or a similar manner. The sheets on the floors of adjacent members, such as the compacting chamber and an adjacent ramp or door, and adjacent ramp or door segments, can have end portions which cooperate to allow folding, pivoting and other relative movements, as desired or required.

As a result, the forces which oppose movement of the compacted body or module of cotton are substantially reduced, to allow usage of fewer conveyor chains and smaller and/or less powerful drive motors for the chains.

### BRIEF DESCRIPTION OF THE DRAWINGS

FIG. 1 is a simplified fragmentary side view of a cotton harvesting machine, including a cotton packager pivoted to an unloading position, and an associated ramp extending from a floor of the packager to a ground surface;

FIG. 2 is a simplified fragmentary perspective representation of the floor of the packager and the ramp, showing the low friction floor surfaces thereof according to the invention;

FIG. 3 is another simplified fragmentary representation of the ramp, showing floor sections thereof;

FIG. 4 is a simplified schematic representation of low friction sheets of the floor surface of the invention, showing one embodiment of adjacent edges thereof; and

FIG. 5 is a simplified schematic representation of low friction sheets of the floor surface of the invention, showing another embodiment of adjacent edges thereof.

### DETAILED DESCRIPTION OF THE INVENTION

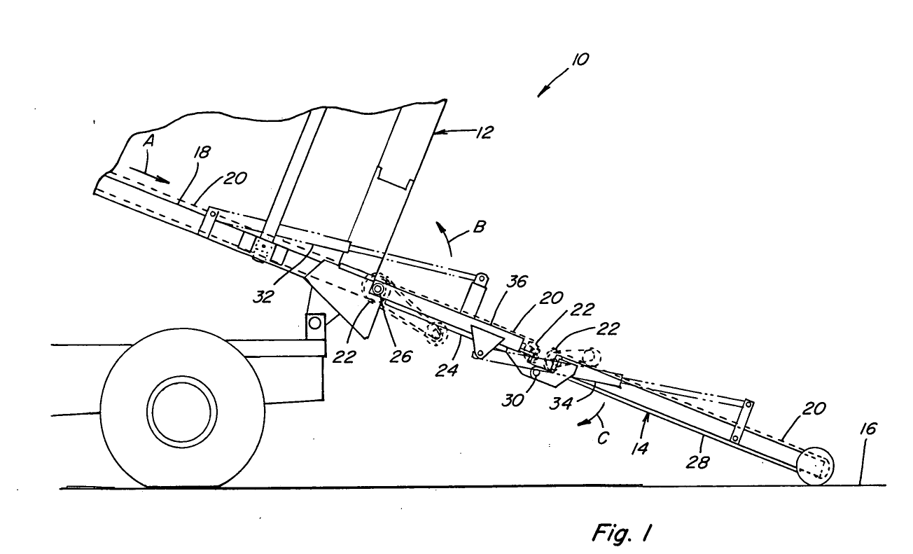

Referring now to the drawings, in FIG. 1, a rear end of a cotton harvesting machine 10 is shown, including a cotton packager 12 of the machine tilted to an unloading position in the well known conventional manner, and an unloading ramp 14 extending rearwardly and downwardly from packager 12 to a ground surface 16, in an unloading position. Cotton packager 12 includes an interior that defines a cotton compacting chamber for receiving cotton from harvesting units (not shown) of machine 10 and in which the harvested cotton is compacted into a unitary body or module of cotton (also not shown) in the well known conventional manner.

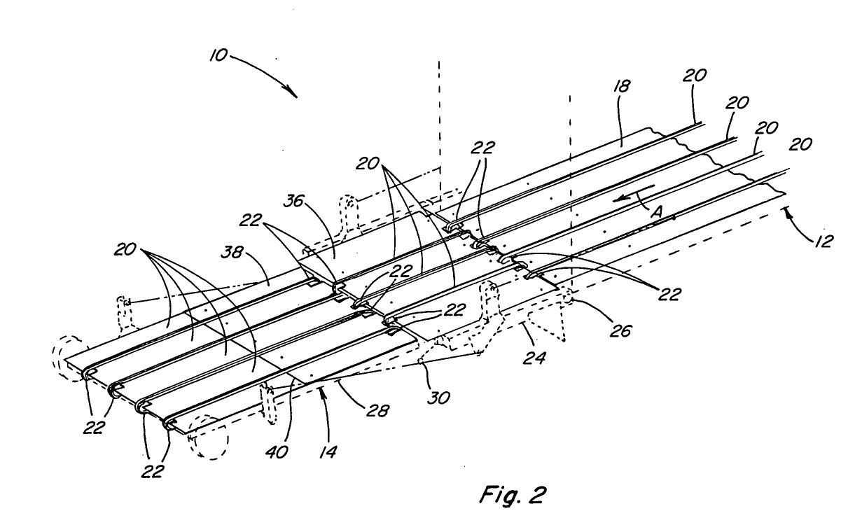

Referring also to FIG. 2, the bottom of the cotton compacting chamber of packager 12 is defined and enclosed by an upwardly facing floor surface 18 comprised of one or more sheets of a low friction polymer material, such as, but not limited to, Alert Manufacturing and Supply Co. A plurality of conveyor chains 20 extend forwardly and rearwardly in spaced relation one to the other over floor surface 18 and encircle sprockets 22. Conveyor chains 20 and sprockets 22 are rotatably drivable using a suitable drive mechanism, which can include a motor, such as, but not limited to, a fluid or electric motor, for moving chains 20 in an unloading direction, denoted by arrow A, over floor surface 18, for conveying a compacted body or module of cotton from the interior chamber.

Floor 18 can comprise a plurality of individual sheets of the low friction polymer material disposed between conveyor chains 20, or one or more larger sheets, and can be located beneath chains 20 for providing a low friction supporting surface therefor. Alternatively, several elements such as channeled guides or the like can be provided beneath chains 20, as desired. The low friction polymer material can be, but is not limited to, a high density polyethylene, an ultrahigh molecular weight polyethylene, or a similar low friction plastics material, preferably having a coefficient of friction within a range of from about 0.1 to about 0.3.

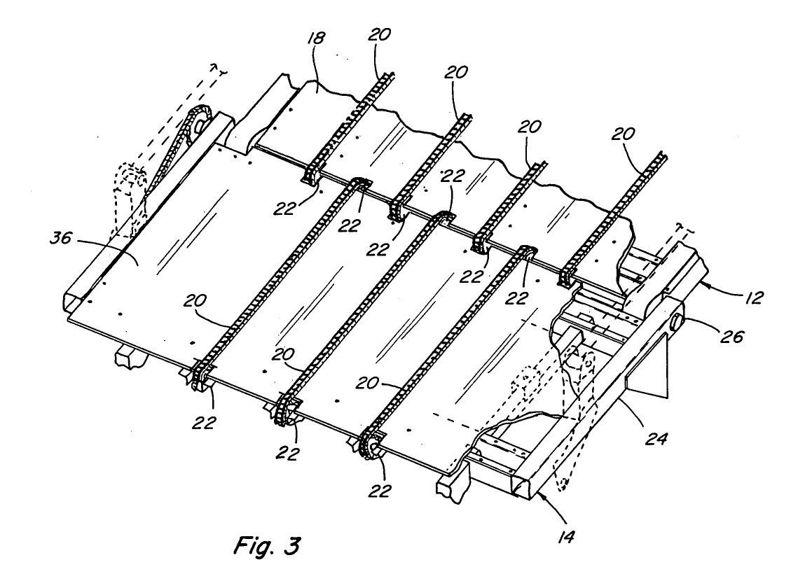

Referring also to FIGS. 3, 4 and 5, unloading ramp 14 includes a first segment 24 pivotally connected at pivot 26 to the rearward end of cotton packager 12 for pivotal movement between an unloading or open position as shown, and a closed position in covering relation to the rearward end of packager 12 (not shown), in the well known manner. Ramp 14 additionally includes a second ramp segment 28 pivotally connected at pivot 30 to first ramp segment 24 for pivotal movement relative to first ramp segment 24 and packager 10, as denoted by arrow B, between the unloading position as shown, and a folded position beside first ramp segment 24 when in its closed position, as denoted by arrow C in FIG. 1. Pivotal movement of first and second ramp segments 24 and 28 is effected, respectively, by fluid cylinders 32 and 34, in the well known manner. First ramp segment 24 includes an upwardly facing floor or conveyor surface 36 which comprises one or more low friction polymer sheets, such as of the above described material, namely, a high density polyethylene, an ultrahigh molecular weight polyethylene, or a similar low friction plastics material, preferably having a coefficient of friction within a range of from about 0.1 to about 0.3, for low friction movement of a compacted body of cotton thereover. Similarly, second ramp surface 28 has a conveyor surface 38 composed of the same material. Each of the ramp segments 24 and 28 includes a plurality of conveyor chains 20 encircling sprockets 22 at the opposite ends of the segment for conveying the cotton thereover. The polymer sheets of surfaces 36 and 38 can support chains 20, in the above-described manner, or separate channels or other elements can be used. Additionally, surfaces 36 and 38 can each comprise a single large sheet of the low friction material, or two or more pieces as desired. For example, referring to FIG. 2, conveyor surface 38 of ramp segment 28 is shown including two sheets of the material which each extend the full width of the ramp, and abut or overlap at line 40.

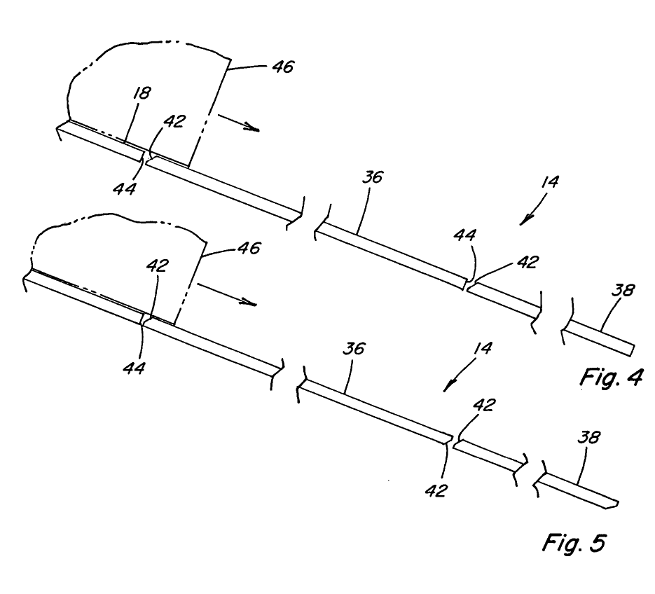

Referring to FIG. 4, proximal edges 42 and 44 of the low friction sheets of surfaces 18, 36 and 38 are shown, for the smooth movement and transition of a compacted body of cotton thereof, denoted by cotton module 46, is shown. Essentially, by providing an upwardly facing bevel or edges 42 on the downstream edge of the surface 36 and/or 38, a smooth transition of the compacted body of cotton thereover is achieved, without tearing and/or slowing the movement of the cotton thereover. Bevels 42 also ensure that when pivoted between the closed and unloading positions, interference between the surfaces is avoided.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

1. A cotton packager, comprising:
a floor surface having an end, and structure supporting the floor surface for pivotal movement between a substantially horizontal first position and a position tilted at an acute angle to the horizontal first position so as to extend downwardly toward the end; and
at least one conveyor chain on the floor surface extending toward the end;
wherein the floor surface comprises at least one sheet of a low friction polymer material.

2. The cotton packager of claim 1, comprising a plurality of the conveyor chains in spaced apart, parallel relation on the floor surface, and the floor surface comprises a plurality of the sheets of the low friction polymer material between the conveyor chains.

3. The cotton packager of claim 1, wherein the floor surface comprises at least one channeled guide beneath the at least one conveyor chain.

4. The cotton packager of claim 1, wherein the at least one conveyor chain is supported on the at least one sheet of the low friction polymer material.

5. The cotton packager of claim 4, comprising a plurality of the conveyor chains extending in substantially parallel, spaced apart relation on the floor surface and extending toward the end thereof.

6. The cotton packager of claim 1, wherein the floor surface comprises a single sheet of the low friction polymer material which encompasses substantially an entire surface area of the floor surface.

7. The cotton packager of claim 1, further comprising an unloading ramp mounted for pivotal movement to an unloading position extending outwardly from the end of the floor in substantially parallel relation thereto, the unloading ramp including at least one conveyor surface comprised of at least one sheet of a low friction polymer material.

8. The cotton packager of claim 7, wherein the unloading ramp includes at least one conveyor chain on the conveyor surface extending away from the end of the floor surface.

9. The cotton packager of claim 8, wherein the at least one conveyor chain is supported on the at least one sheet of the low friction polymer material of the conveyor surface.

10. The cotton packager of claim 7, wherein the at least one sheet of the low friction polymer material extends an entire width of the conveyor surface of the unloading ramp.

11. The cotton packager of claim 7, wherein the at least one sheet of the low friction polymer material of the conveyor surface is located in closely spaced, edge-to-edge relation to the at least one sheet of the low friction polymer material of the floor surface when the unloading ramp is in the unloading position.

12. The cotton packager of claim 1, wherein the unloading ramp comprises a plurality of ramp segments, each of the ramp segments comprising a conveyor surface comprised of at least one sheet of the low friction polymer material.

13. The cotton packager of claim 12, wherein the ramp segments are pivotable one relative to the other, and when the ramp segments are in the unloading position, the sheets of the low friction polymer material of the conveyor surfaces of the ramp segments are located in end-to-end relation.

14. The cotton packager of claim 1, wherein the low friction polymer material is selected from a group consisting of a high density polyethylene and an ultrahigh molecular weight polyethylene.

15. The cotton packager of claim 1, wherein the low friction polymer material has a coefficient of friction within a range of from about 0.1 to about 0.3.

16. A cotton packager, comprising a floor surface adapted for supporting a compacted body of cotton thereon, the floor surface being tiltable to an acute angle to horizontal of up to about 25°;
an unloading ramp including a conveyor surface over which a compacted body of cotton can be conveyed, the unloading ramp being pivotally mounted to the packager so as to be positionable in an unloading position extending outwardly from the floor surface; and
conveyor chains extending across the floor surface and the conveyor surface;
wherein the floor surface and the conveyor surface each comprises at least one sheet of a low friction polymer material.

17. The cotton packager of claim 16, wherein the conveyor chains are located in channels on the floor surface and the conveyor surface.

18. The cotton packager of claim 16, wherein the floor surface and the conveyor surface each comprise a single sheet of the low friction polymer material which substantially covers an entire area thereof.

19. The cotton packager of claim 16, wherein the conveyor chains are supported on the sheets of the low friction polymer material.

20. The cotton packager of claim 16, wherein the low friction polymer material is selected from a group consisting of a high density polyethylene and an ultrahigh molecular weight polyethylene.

21. The cotton packager of claim 16, wherein the low friction polymer material has a coefficient of friction within a range of from about 0.1 to about 0.3.
